(19) United States
(12) Patent Application Publication
(10) Pub. No.: US 2025/0019003 A1
(43) Pub. Date: Jan. 16, 2025

(54) SELF-PROPELLED VEHICLE, IN PARTICULAR SELF-PROPELLED LOAD-HANDLING VEHICLE

(71) Applicant: MANITOU BF, ANCENIS (FR)

(72) Inventor: Maxime VINCONNEAU, ANCENIS (FR)

(21) Appl. No.: 18/712,005

(22) PCT Filed: Oct. 26, 2022
(86) PCT No.: PCT/FR2022/052035

§ 371 Date: May 21, 2024

(30) Foreign Application Priority Data
Nov. 23, 2021 (FR) 2112369

(51) Int. Cl. B62D 7/14; B62D 5/06; B62D 5/12; B62D 5/18; B66F 9/065

(52) U.S. Cl. CPC B62D 7/142; B62D 5/062; B62D 5/12; B62D 5/18; B66F 9/065

(57) ABSTRACT

The invention relates to a vehicle comprising front and rear axles, one steering mechanism (6) per axle, comprising a cylinder (7) having a body and two pistons, each associated with a rod and dividing the body into a central chamber extending between the pistons and two end chambers, said vehicle comprising a first configuration wherein the wheels (4, 5) of a single axle extend in parallel planes, and a second O-shaped configuration wherein the wheels (4, 5) are arranged on a circle, and a configuration selector. The vehicle comprises, for fluid connection of the cylinders (7) of the steering mechanisms (6) to the source or sources (17, 18) of pressurised fluid, a first circuit (15) of fluid active in the first configuration, and a second circuit (16) of fluid active in the second configuration, the second circuit (16) being, for the cylinder (7) of each steering mechanism (6), configured so that when the central chamber of said cylinder forms an inlet chamber, the end chambers of said cylinder form exhaust chambers, and vice versa, this second circuit (16) of fluid being equipped with a flow divider (25).

The present invention relates to a self-propelled vehicle, notably a self-propelled load-handling vehicle.

It relates in particular to a self-propelled vehicle comprising a front driving and steering axle with two wheels and a rear driving and steering axle with two rear wheels, each axle being equipped with a steering mechanism, each steering mechanism comprising a double-acting cylinder which can be connected to a pressurized-fluid source, said cylinder comprising a body which is elongate from one end to the other end of said body and two pistons, each associated with an output rod for directional control of one wheel of the axle, said pistons dividing the body into a central chamber extending between the pistons and two end chambers each disposed on a rod side, said vehicle comprising two configurations and a manual selector for selecting one configuration or the other, the first configuration, referred to as normal configuration, corresponding to a configuration in which the wheels of one and the same axle extend in substantially parallel planes, the second configuration, referred to as “O” configuration, corresponding to a configuration in which the wheels of the vehicle are placed on a circle of which the center passes through an axis referred to as vertical axis, for a rotation of the vehicle on itself about said axis, the central chamber of each cylinder not being supplied with fluid in the first configuration such that, in this first configuration, the cylinder of each steering mechanism forms the equivalent of a cylinder with a piston and two rods, the central chamber being in the second configuration, in which it is able to be supplied with fluid.

A self-propelled vehicle equipped with such a steering device is known, as illustrated in patent EP 2 570 331. Patent US 2008/001380 also describes a self-propelled vehicle with an “O” configuration. To allow optimum operation of such steering, it is necessary to perfectly manage the end-of-travel positions of the cylinders of the transmission mechanisms without the wheels being necessarily parallel in the first configuration.

One aim of the invention is to propose a self-propelled vehicle of the aforementioned type, the design of which makes it possible to define the end-of-travel positions of the cylinders with precision.

Another aim of the invention is to propose a self-propelled vehicle of the aforementioned type, the design of which allows increased mechanical strength of the steering mechanisms.

To this end, the invention relates to a self-propelled vehicle, notably a self-propelled load-handling vehicle, said vehicle comprising a front driving and steering axle with two front wheels and a rear driving and steering axle with two rear wheels, each axle being equipped with a steering mechanism, each steering mechanism comprising a double-acting hydraulic cylinder which can be connected to a pressurized-fluid source, said cylinder comprising a body which is elongate from one end to the other end of said body and two pistons, each associated with an output rod for directional control of one wheel of the axle, said pistons dividing the body into a chamber, referred to as central chamber, extending between the pistons and two end chambers each disposed on a rod side, said vehicle comprising two configurations and a selector for selecting one configuration or the other, the first configuration, referred to as normal configuration, corresponding to a configuration in which the wheels of one and the same axle extend in substantially parallel planes, the second configuration, referred to as “O” configuration, corresponding to a configuration in which the wheels of the vehicle are placed on a circle of which the center passes through an axis referred to as vertical axis, for a rotation of the vehicle on itself about said axis, the central chamber of each cylinder not being supplied with fluid in the first configuration such that, in this first configuration, the cylinder of each steering mechanism forms the equivalent of a cylinder with a piston and two rods, the central chamber being in the second configuration, in which it is able to be supplied with fluid, characterized in that the vehicle comprises, to fluidically connect the cylinders of the steering mechanisms to the one or more pressurized-fluid sources, a first and a second fluid circuit, the first fluid circuit being an active circuit in the first configuration, the second fluid circuit being an active circuit in the second configuration, the second fluid circuit being, for the cylinder of each steering mechanism, configured such that, when the central chamber of said cylinder forms an intake chamber, the end chambers of said cylinder form exhaust chambers, and vice versa, this second fluid circuit being equipped with a flow splitter for supplying each end chamber with fluid at the same flow rate. The fact that the second circuit is equipped with a flow splitter makes it possible to ensure the pistons return to the median zone of the body of the cylinder, the median zone of said body being considered with reference to the two ends of said body.

According to one embodiment of the invention, the flow splitter of the second fluid circuit, which is preferably a geared flow splitter, is interposed between the pressure source of the second fluid circuit and the end chambers of the cylinders.

According to one embodiment of the invention, the second circuit comprises a first circuit portion between the pressurized-fluid source of the second circuit and the central chamber of each cylinder and a second circuit portion extending between the pressurized-fluid source of the second circuit and each end chamber of each cylinder, the first circuit portion extends from the pressurized-fluid source of the second circuit to a connection node where said first circuit portion is divided into two sections, one of which connects the connection node to the central chamber of one of the cylinders and the other one of which connects the connection node to the central chamber of the other cylinder, and the second circuit portion is divided at the flow splitter into four sections each connecting the flow splitter to an end chamber of a cylinder that is distinct from one section to the next.

According to one embodiment of the invention, the second fluid circuit is equipped with an at least three-position directional control valve interposed between the pressurized-fluid source of the second fluid circuit and the cylinders, the first position of the directional control valve, in which no chamber of the cylinders is supplied by said second fluid circuit, corresponds to the selector being positioned in the first configuration, the second position of the directional control valve, in which the central chamber of each cylinder is a fluid supply chamber and the end chambers are exhaust chambers, corresponds at least to the selector being positioned in the second configuration, and the third position of the directional control valve, in which the central chamber is an exhaust chamber and the end chambers are fluid supply chambers, corresponds to the selector being moved in order to change from the second to the first configuration.

According to one embodiment of the invention, the first and second fluid circuits each comprise at least one individual circuit portion and one circuit portion shared with the other circuit, the or at least one of the portions shared by the first and second circuits is placed between one of the end chambers of a cylinder and a junction node provided with a switching member, said switching member is mounted movably between a first position, in which the shared portion is in fluidic communication with an individual portion of the first circuit, and a second position, in which the shared portion is in fluidic communication with an individual portion of the second circuit, and the first position of the switching member corresponds to the selector being positioned in the first configuration, and the second position of the switching member corresponds to the selector being positioned in the second configuration.

According to one embodiment of the invention, the vehicle comprises a control unit for the or each switching member, said control unit being configured to acquire data regarding the position of the selector and to control the switching members as a function of said data. This results in simplicity of construction.

According to one embodiment of the invention, the body of each cylinder comprises, to supply the central chamber of said cylinder with fluid, an opening formed in the median zone of said body considered with reference to the two ends of said body.

According to one embodiment of the invention, at least part of the opening formed in the median zone of the body of each cylinder considered with reference to the two ends of said body extends equidistantly from the ends of said body. This design makes it possible to increase the mechanical strength of the cylinder.

According to one embodiment of the invention, in the first configuration, the pistons of one and the same cylinder move conjointly by simply making bearing contact against one another. This results in a simplified construction.

According to one embodiment of the invention, the vehicle comprises a first detection device for detecting at least one parameter indicative of the position referred to as straight position of the front wheels and a second detection device for detecting at least one parameter indicative of the position referred to as straight position of the rear wheels, the straight position of the front or respectively rear wheels corresponds to a position in which the front or respectively rear wheels are parallel to one another and to the longitudinal axis of the vehicle considered along the front/rear direction of the vehicle, and the vehicle comprises a control unit configured to permit the actuation of the selector and allow it to change from the position corresponding to the first configuration to the position corresponding to the second configuration solely in the straight position of the front and rear wheels.

The presence of the first and second detection devices makes it possible to ensure a change from the first configuration to the second configuration in the straight position of the wheels to avoid an imperfect positioning in an O shape of the wheels in the second configuration.

### BRIEF DESCRIPTION OF THE DRAWINGS

The invention will be clearly understood on reading the following description of exemplary embodiments, with reference to the appended drawings, in which:

FIG. 1 shows a side view of a vehicle according to the invention;

FIG. 2 shows a schematic partial view of the inside of the driver's cab of the vehicle;

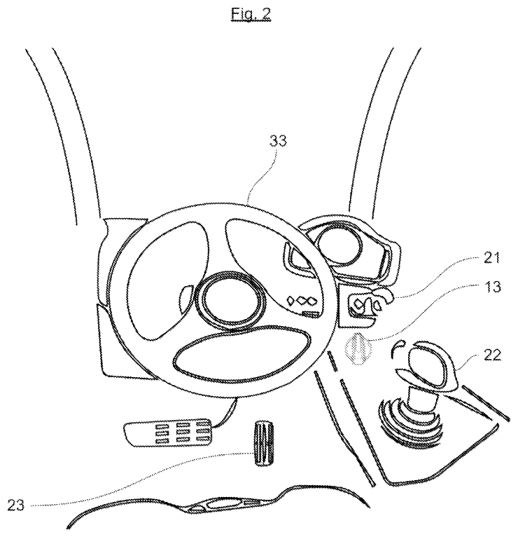

FIG. 3 shows a schematic top view of the hydraulic circuits linked to the driving and steering axles in the first configuration of the vehicle;

FIG. 4 shows a schematic top view of the hydraulic circuits linked to the driving and steering axles in the second configuration of the vehicle;

FIG. 5 shows a schematic top view of the hydraulic circuits linked to the driving and steering axles when changing from the second configuration to the first configuration of the vehicle;

FIG. 6A shows a schematic view of a cylinder in the end position of steering the wheels of the front axle to the right in the first configuration of the vehicle;

FIG. 6B shows a schematic view of a cylinder in the end position of steering the wheels of the front axle to the left in the first configuration of the vehicle;

FIG. 7A shows a schematic view of a cylinder in the toe-in or toe-out position of the wheels in the second configuration of the vehicle;

FIG. 7B shows a schematic view of a cylinder in the toe-in or toe-out position of the wheels in the second configuration of the vehicle.

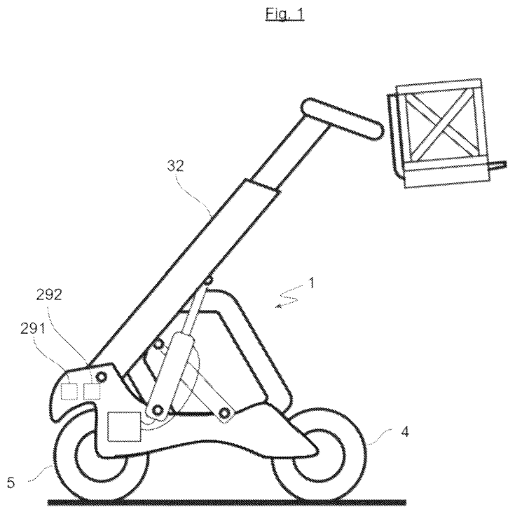

As mentioned above, the invention relates to a self-propelled vehicle 1, which may be of the type shown in FIG. 1. FIG. 1 shows a self-propelled load-handling vehicle 1.

This vehicle 1 comprises a rolling chassis equipped with a driver's cab and bearing a load lifting arm 32 mounted pivotably about a horizontal axis on the chassis.

This vehicle 1 comprises, at the rolling chassis of the vehicle 1, a front driving and steering axle 2 with two front wheels 4 and a rear driving and steering axle 3 with two rear wheels 5.

Each driving and steering axle 2 or 3 may be equipped with a differential for rotating the wheels. Each driving and steering axle is driven via an input shaft. This input shaft is connected to a gearbox output in a manner known per se.

It is possible to make the wheels of one and the same axle rotate with one and the same rotational speed in one and the same direction of rotation or in two opposite directions of rotation. For such a rotation of the wheels in opposite directions, the differential may be a reversing differential or an auxiliary motor may be provided.

Each axle 2 or 3 is thus configured to make it possible to rotate the wheels of said axle in one and the same direction of rotation and in opposite directions of rotation. This rotation of the wheels, in one and the same direction or in opposite directions, depending on the operating mode and in particular on the configuration taken by the vehicle, will not be described in more detail below as it is well known to those skilled in this art.

Each driving and steering axle 2 or 3 is furthermore equipped with a steering mechanism 6. Each steering mechanism 6 comprises a double-acting hydraulic cylinder 7 which can be connected to at least one pressurized-fluid source.

In the examples shown, two fluid sources, respectively referenced 17 and 18, are provided and will be described in more detail below.

The cylinder 7 of each steering mechanism 6 comprises a body 8 which is elongate from one end to the other end of said body 8 and two pistons 91, 92, each associated with an output rod for directional control of one wheel of the axle. The pistons 91 and 92 divide the body 8 into a chamber 11, referred to as central chamber, extending between the pistons 91 and 92, and two end chambers 121, 122 each placed on a rod side. The rod 101 is associated with the piston 91, whereas the rod 102 is associated with the piston 92.

Each output rod 101 or 102 of the cylinder 7 is coupled at the axle to one wheel of the axle in order to orient the wheel by rotating the front wheel 4 or rear wheel 5 about an axis transverse to the axis of rotation of the wheel under the action of said output rod. Each output rod 101 or 102 is thus connected to a pivot of the wheel by a steering link rod, in a manner known per se. The movement of the rod of the cylinder is transmitted by the link rod to the pivot pin of the wheel to rotate the wheel about a vertical axis when the vehicle is positioned on a horizontal flat surface.

In practice, in the output position of the two rods 101 and 102 of the pistons 91 and 92 of the cylinder 7 with which the front driving and steering axle 2 is equipped, the front wheels 4 assume a toe-in position, which is to say they converge and point toward the inside of the vehicle while forming a re-entrant angle with respect to the longitudinal axis of the vehicle considered along the front/rear direction. In the output position of the two rods 101 and 102 of the pistons 91 and 92 of the cylinder 7 with which the rear driving and steering axle 3 is equipped, the rear wheels 5 assume a toe-out position, which is to say they converge and point toward the outside of the vehicle while forming a salient angle with respect to the longitudinal axis of the vehicle considered along the front/rear direction.

The vehicle 1 comprises two configurations and a selector 13 or controller with manual actuation for selecting one configuration or the other. This selector 13 may take a great many forms. In its simplest version, it may be formed by a simple button which is placed in the driver's cab and can be actuated by the operator to change from one configuration to another. In the example shown, the selector 13 is a button with two positions.

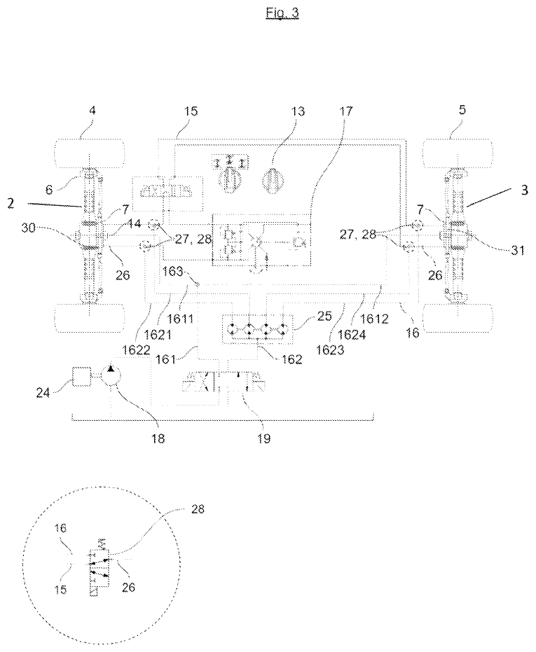

The wheels of one and the same axle extend in planes that are substantially parallel, which is to say parallel to within +20° in the first configuration as illustrated in FIG. 3. The wheels of one and the same axle are intended to turn in the same direction in the first configuration.

In the second configuration, the wheels of one and the same axle are placed on a circle C with a center passing through an axis A, referred to as vertical axis, to allow the vehicle 1 to rotate on itself about said axis A when the vehicle 1 is positioned on a horizontal flat surface, and when the wheels of one and the same axle are rotated in opposite directions of rotation. The wheels of one and the same axle are thus counter-rotating wheels rotated in opposite directions and the axes of rotation of the wheels form an angle equal to 90°, to within 20°, between them.

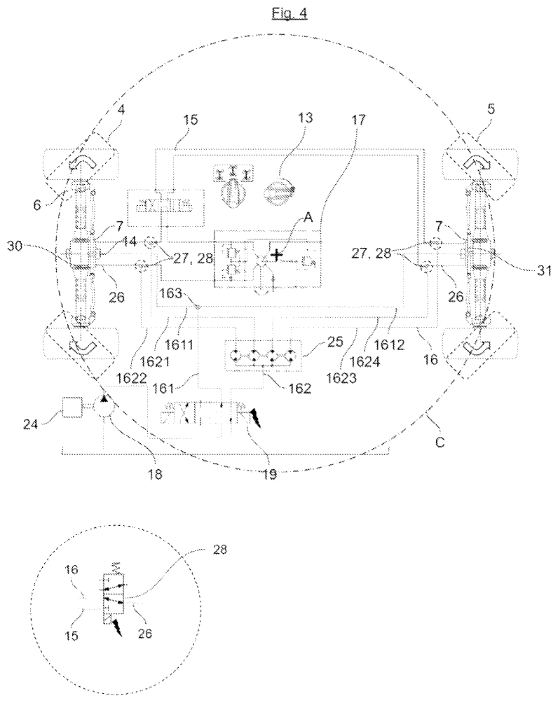

This second configuration, or “O” configuration, of the wheels is illustrated by the wheels in dashed line in FIG. 4.

In other words, in this second configuration of the vehicle 1, the front wheels are in a toe-in position and the rear wheels are in a toe-out position. In this second configuration, the counter-rotating wheels of one and the same axle are intended to turn in opposite directions.

In the first configuration, the central chamber 11 of each cylinder 7 is not supplied with fluid. In the first configuration, the end chambers of the cylinder 7 of the front driving and steering axle 2 form either a fluid intake chamber or a fluid exhaust chamber. The same applies for the cylinder 7 of the rear driving and steering axle 3 when the four wheels are steered in this first configuration.

In the first configuration, only the end chambers 121, 122 of the cylinders 7 can be supplied with fluid, such that, for one and the same axle, when one of the end chambers of the cylinder 7 of the steering mechanism 6 of the axle forms a fluid intake chamber, the other end chamber forms a fluid exhaust chamber.

As illustrated by the symbols in FIG. 3, various possibilities can thus exist in the first configuration, specifically for example:
operation with four steered wheels parallel to one another in pairs. In this case, the end chambers of the cylinders of the two axles are able to be supplied with fluid in such a way that when the mutually parallel front wheels turn to the right, the mutually parallel rear wheels turn to the left, and vice versa.
operation with two steered wheels; in this case, the end chambers of the cylinder of the front axle are able to be supplied with fluid, the cylinder of the rear axle not being supplied with fluid.
operation referred to as crab operation, with four steered wheels parallel to one another. In this case again, the end chambers of the cylinders of the two axles are able to be supplied with fluid.

In this first configuration, in which the central chamber 11 of each cylinder 7 is not being supplied with fluid, the pistons 91 and 92 of one and the same cylinder 7 move conjointly. As a result, in this first configuration, the cylinder 7 of each steering mechanism 6 forms the equivalent of a cylinder with one piston and two rods. That is why, in this first configuration, when a cylinder 7 is being supplied with fluid, of the end chambers 121 and 122 of the cylinder 7 one forms a fluid intake chamber and the other forms a fluid exhaust chamber.

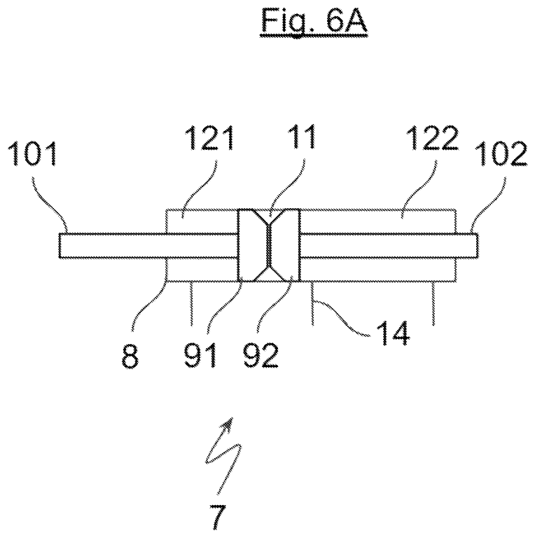

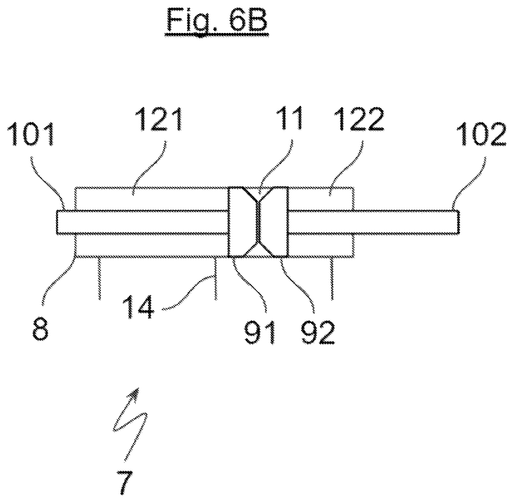

Thus, for example, as illustrated in FIGS. 6A and 6B, if the cylinder 7 shown is assumed to be that of the steering mechanism 6 for the front axle, when the end chamber 122 that forms the intake chamber is supplied with fluid, the rod 102 of the piston 92 enters the body 8 of the cylinder 7, whereas the rod 101 of the piston 91 leaves the body 8 of the cylinder 7, the end chamber 121 constituting the fluid exhaust chamber, this consequently causing the front wheels to rotate to the right.

Conversely, in FIG. 6B, when the end chamber 121 that forms the intake chamber is supplied with fluid, the rod 101 of the piston 91 enters the body 8 of the cylinder 7, whereas the rod 102 of the piston 92 leaves the body 8 of the cylinder, the end chamber 122 forming the exhaust chamber, this consequently causing the front wheels to rotate to the left.

In the straight position of the wheels, which is to say when the front wheels extend parallel to the longitudinal axis of the vehicle considered along the front/rear direction, the pistons 91 and 92 of the cylinder 7 are in the median zone of the body 8 considered with reference to the ends of the body 8.

To allow the cylinders 7 of the steering mechanisms 6 to operate in the first configuration, the cylinders 7 of the steering mechanisms must be fluidically connected to the or one of the pressurized-fluid sources. To this end, the vehicle 1 comprises a first fluid circuit 15. This first fluid circuit 15 is active, which is to say biased in the first configuration. In the biased state, this first circuit is supplied with pressurized fluid.

In the examples shown, this first circuit 15 is connected to a fluid source, referenced 17 in the figures. This first circuit 15 comprises, at the fluid source 17 and in a manner known per se, a steering unit, such as a hydrostatic servocontrol device, also known by the name Orbitrol (registered trade mark). This steering unit may comprise a pump and a rotary directional control valve engaged with a steering control member, such as the steering wheel 33 of the vehicle.

The rotation of the steering wheel 33 causes the pump and the rotary directional control valve to be actuated in order to supply the first fluid circuit 15. This first fluid circuit 15 comprises, over at least some of its course, a multi-position directional control valve which makes it possible either to supply exclusively one or the other of the end chambers of the cylinder 7 of the front axle in the case of a first configuration with two steered front wheels, or to supply one or the other of the end chambers of the cylinder 7 of the front axle and one or the other of the end chambers of the cylinder 7 of the rear axle to obtain the various operating possibilities in terms of steered wheels described above, namely four steered wheels that are parallel in pairs or four parallel steered wheels (in crab operation).

This first fluid circuit 15 will not be described in more detail as it corresponds to conventional operation of the steering of such a vehicle.

It should be noted that, in the first configuration, the pistons 91 and 92 of one and the same cylinder 7 move conjointly by simply making bearing contact against one another. Thus, each time an end chamber of a cylinder is supplied with fluid, the piston serving to delimit said end chamber acts as a pusher of the piston serving to delimit the other end chamber.

In the second configuration, the central chamber 11 of the cylinder 7 of each steering mechanism is able to be supplied with fluid. To this end, the body 8 of each cylinder 7 comprises, to supply the central chamber 11 of said cylinder 7 with fluid, an opening 14 formed in the median zone of the body 8 considered with reference to the two ends of the body 8. At least part of this opening 14 formed in the median zone of the body 8 of each cylinder 7 extends equidistantly from the ends of the body 8.

The body 8 of each cylinder 7 of course also comprises, at each end of the body, an opening for supplying an end chamber of the cylinder 7 with fluid.

The vehicle 1 comprises a second fluid circuit 16 biased in the second configuration. This second fluid circuit 16 active in the second configuration is connected to a pressurized-fluid source referenced 18 in the figures. This second fluid circuit 16 is, for the cylinder 7 of each steering mechanism 6, configured such that, when the central chamber 11 of the cylinder 7 forms an intake chamber, the end chambers 121 and 122 of said cylinder 7 form exhaust chambers, and vice versa.

Thus, when the central chamber 11 of each cylinder 7 is supplied with fluid and forms the intake chamber and when the end chambers of each cylinder 7 form the exhaust chambers, the front wheels 4 and rear wheels 5 of the vehicle 1 are brought into the second, “O” configuration. Conversely, when the central chamber 11 of each cylinder 7 forms the exhaust chamber and when the end chambers 121 and 122 of each cylinder 7 form the fluid supply chambers, the wheels change from the second, “O” configuration to the first configuration, in which the wheels of one and the same axle extend parallel to one another.

At the end-of-travel position of the wheels, upon changing from the second configuration to the first configuration, the wheels extend parallel to the longitudinal axis of the vehicle considered along the front/rear direction. In this position of the wheels, referred to as straight position of the wheels, the pistons 91 and 92 of a cylinder 7 extend in the median zone of the body 8 of the cylinder. This median zone is considered with reference to the ends of the body 8 of the cylinder 7.

To ensure the pistons 91, 92 of one and the same cylinder 7 return to the median position, the second fluid circuit 16 is equipped with a flow splitter 25 for supplying each end chamber 121, 122 of the cylinder 7 at the same flow rate.

In the examples shown, the flow splitter 25 of the second fluid circuit 16, which is preferably a geared flow splitter 25, is interposed between the pressure source 18 of the second fluid circuit 16 and the end chambers 121 and 122 of the cylinders 7.

The pressure source 18 of the second fluid circuit 16 is formed in this instance by a hydraulic pump driven by a motor 24. This motor 24 may be an electric motor or a combustion engine.

The second circuit 16 comprises a first circuit portion 161 between the pressurized-fluid source 18 of the second circuit 16 and the central chamber 11 of each cylinder 7 and a second circuit portion 162 extending between the pressurized-fluid source 18 of the second circuit and each end chamber 121, 122 of each cylinder 7. The first circuit portion 161 extends from the pressurized-fluid source 18 of the second circuit 16 to a connection node 163 where said first circuit portion 161 is divided into two sections 1611, 1612, one of which connects the connection node 163 to the central chamber 11 of one of the cylinders 7 and the other one of which connects the connection node 163 to the central chamber 11 of the other cylinder 7. The second circuit portion 162 is divided at the flow splitter 25 into four sections 1621, 1622, 1623, 1624 each connecting the flow splitter 25 to an end chamber 121, 122 of a cylinder 7 that is distinct from one section to the next. This second circuit is shown, for example, in FIG. 3.

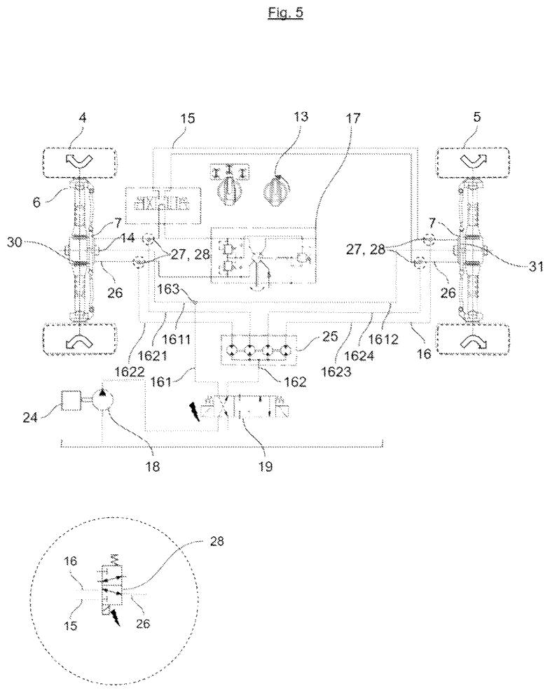

The second fluid circuit 16 is equipped with an at least three-position directional control valve 19 interposed between the pressurized-fluid source 18 of the second fluid circuit 16 and the cylinders 7. The first position of the directional control valve 19, in which no chamber of the cylinders 7 is being supplied by said second fluid circuit 16, corresponds to the selector 13 being positioned in the first configuration (FIG. 3). The second position of the directional control valve 19, in which the central chamber 11 of each cylinder 7 is a fluid supply chamber and the end chambers 121, 122 are exhaust chambers, corresponds at least to the selector 13 being positioned in the second configuration (FIG. 4), and the third position of the directional control valve 19, in which the central chamber 11 is an exhaust chamber and the end chambers 121, 122 are fluid supply chambers, corresponds to the selector 13 being moved in order to change from the second to the first configuration (FIG. 5).

The at least three-position directional control valve 19 is a 4/3 directional control valve. This directional control valve 19 is returned to the first position, in which no chamber of the cylinders is supplied by the second fluid circuit 16, by a spring.

This three-position directional control valve 19 can be supplied with a first electrical signal to change to the second position and with a second electrical signal to change to the third position.

Each time, the absence of an electrical signal allows the three-position directional control valve 19 to return to the first position.

The first and second fluid circuits may be independent. In a variant, and like in the example shown, the first and second fluid circuits 15, 16 each comprise at least one individual circuit portion and one circuit portion 26 shared with the other circuit, and the or at least one of the portions 26 shared by the first and second circuits 15, 16 is placed between one of the end chambers 121, 122 of a cylinder 7 and a junction node 27 provided with a switching member 28. Said switching member 28 is mounted movably between a first position, in which the shared portion 26 is in fluidic communication with an individual portion of the first circuit 15 (FIG. 3), and a second position, in which the shared portion 26 is in fluidic communication with an individual portion of the second circuit 16 (FIGS. 4 and 5), and the first position of the switching member 28 corresponds to the selector 13 being positioned in the first configuration, and the second position of the switching member 28 corresponds to the selector 13 being positioned in the second configuration.

In the example shown, this switching member 28 is a two-position directional control valve, which is to say a 3/2 solenoid valve with one of the positions corresponding to the position taken by the directional control valve or the solenoid valve in the first configuration and the other one of the positions corresponding to the position taken by the directional control valve or the solenoid valve in the second configuration.

This directional control valve or solenoid valve is returned to the position corresponding to the first configuration by a spring and is supplied with power in order to change to the position corresponding to the second configuration.

The vehicle 1 also comprises a control unit 292. Said control unit 292 takes the form of an electronic computer system which comprises, for example, a microprocessor and a working memory. According to a particular aspect, the control unit may be in the form of a programmable automaton. In other words, the functions and steps described may be implemented in the form of a computer program or using hardware components (for example programmable gate arrays). In particular, the functions and steps performed by the control unit or its modules may be performed by sets of instructions or computer modules implemented in a processor or controller or may be performed by dedicated electronic components or components of the programmable logic circuit (or FPGA, which stands for field-programmable gate array) type or of the application-specific integrated circuit (ASIC) type. It is also possible to combine computer portions and electronic portions. When it is specified that the unit or means or modules of said unit are configured to perform a given operation, that means that the unit comprises computer instructions and the corresponding means of execution to allow said operation to be performed and/or that the unit comprises corresponding electronic components.

The control unit 292 is configured to acquire data regarding the position of the selector 13 and to control the switching members 28 as a function of said data. As a result, each switching member 28 as described above is supplied or not supplied with power depending on the position of the selector 13.

Lastly, in order to improve the vehicle 1, it comprises a first detection device 30 for detecting at least one parameter indicative of the position referred to as straight position of the front wheels 4 and a second detection device 31 for detecting at least one parameter indicative of the position referred to as straight position of the rear wheels 5, it being recalled that the straight position of the front wheels 4 or respectively rear wheels 5 corresponds to a position in which the front wheels 4 or respectively rear wheels 5 are parallel to one another and to the longitudinal axis of the vehicle considered along the front/rear direction of the vehicle 1.

These first and second detection devices are of the same type and can take a good many forms. Thus, only a single detection device will be described below.

The first detection device 30 may therefore be a position sensor which detects a dark ring on the rod 101 of the cylinder 7. Each cylinder 7 is equipped with such a ring and an associated optical sensor. When the first detection device 30 detects the dark ring at the front and the second detection device 31 detects the dark ring at the rear, the wheels are in the straight position and an indicator light 21 may be lit up in the driver's cab of the vehicle to notify the driver of the vehicle.

The vehicle 1 comprises a control unit 291 configured to permit the actuation of the selector 13 and to allow it to change from the position corresponding to the first configuration to the position corresponding to the second configuration solely in the straight position of the front wheels 4 and rear wheels 5 of the vehicle 1.

It should be noted that this control unit 291 and the control unit 292 that were described above are similar and can be implemented by just one and the same control unit.

In practice, the vehicle 1 operates as follows.

The wheels of the vehicle 1 are assumed to be in the first configuration, as illustrated in FIG. 3. In this first configuration, the three-position directional control valve 19 of the second fluid circuit 16 is in a position in which no chamber of the cylinder 7 is supplied by the pressurized-fluid source 18 of the second fluid circuit 16. The switching members 28 are in the first position, in which the shared circuit portion 26 is in fluidic communication with an individual portion of the first circuit 15.

In this first configuration, the vehicle 1 can function with two steered wheels, four steered wheels or in crab operation depending on the position of the directional control valve placed on this first fluid circuit 15, it being understood that each time the wheels of one and the same axle are parallel to one another.

If the driver of the vehicle wants the front and rear wheels of the vehicle to be in the second configuration, which is to say in an “O” configuration as illustrated by the wheels in dashed line in FIG. 4, the driver first of all ensures that the forward gear/reverse gear/neutral control member 22, such as a control lever, also referred to as joystick, of the vehicle is in the neutral position, and that the vehicle is at a standstill, which is to say that the parking brake is on and the wheels are aligned in the straight position, it being possible to notice this by virtue of the first detection device 30 and the second detection device 31, a light indicator 21 being lit up when the straight position is reached.

The driver can then actuate the selector 13 in order to change to the second configuration. The one or more control units of the vehicle then simultaneously control the three-position directional control valve 19 and the switching members 28 so as to make it possible to supply the central chamber 11 of the cylinders 7 with fluid via the second fluid circuit 16 from the fluid source 18.

The driver of the vehicle 1 accelerates the engine 24, using the gas pedal 23 of the vehicle, in order to actuate the constituent pump of the pressurized-fluid source 18 of the second fluid circuit 16 and the wheels take the “O” position in FIG. 4.

In this second configuration, the vehicle 1 may turn on itself when at least one of the wheels of the vehicle is rotating.

If the driver of the vehicle wants the wheels to return to the first configuration, they return the forward gear/reverse gear/neutral control member 22 of the vehicle to the neutral position and actuate the parking brake to ensure the speed of the vehicle is zero.

They then actuate the selector 13 to bring it into the first configuration, the consequence of this being to move said three-position directional control valve 19 into a position in which the central chamber forms the exhaust chamber and the end chambers form the fluid intake chambers of each cylinder 7 (FIG. 5).

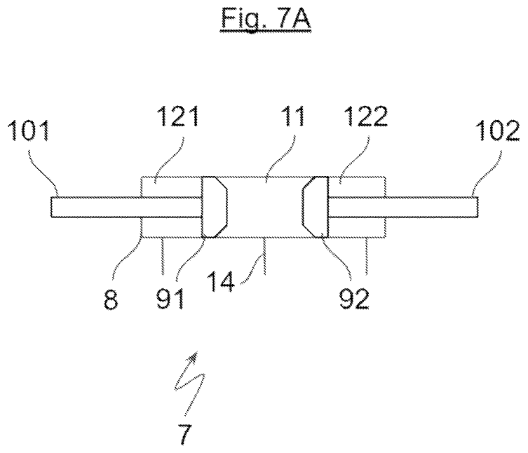

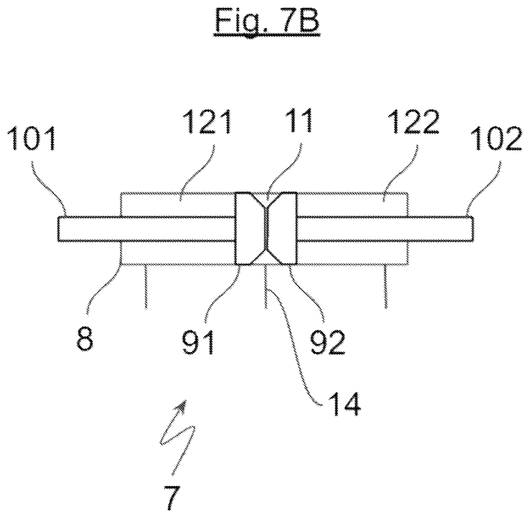

The flow splitter 25 with which the second fluid circuit 16 is equipped makes it possible to supply all the end chambers at the same flow rate, ensuring the pistons of the cylinders return to the median zone, as shown in FIG. 7B.

The control unit then commands the power supply to the three-position directional control valve 19 and the control members 28 to stop, the directional control valve and the control members then being automatically returned to the position corresponding to the first configuration (FIG. 3) under the effect of the springs with which they are equipped.

Operation of the vehicle in the first configuration can then be carried out again.

1. Self-propelled vehicle (1), notably a self-propelled load-handling vehicle, said vehicle (1) comprising a front driving and steering axle (2) with two front wheels (4) and a rear driving and steering axle (3) with two rear wheels (5), each axle (2, 3) being equipped with a steering mechanism (6), each steering mechanism (6) comprising a double-acting hydraulic cylinder (7) which can be connected to a pressurized-fluid source (17, 18), said cylinder (7) comprising a body (8) which is elongate from one end to the other end of said body and two pistons (91, 92), each associated with an output rod (101, 102) for directional control of one wheel of the axle, said pistons (91, 92) dividing the body (8) into a chamber (11), referred to as central chamber, extending between the pistons (91, 92) and two end chambers (121, 122) each disposed on a rod (101; 102) side, said vehicle (1) comprising two configurations and a selector for selecting one configuration or the other, the first configuration, referred to as normal configuration, corresponding to a configuration in which the wheels (4, 5) of one and the same axle (2, 3) extend in substantially parallel planes, the second configuration, referred to as “O” configuration, corresponding to a configuration in which the wheels (4, 5) of the vehicle are placed on a circle (C) of which the center passes through an axis (A) referred to as vertical axis, for a rotation of the vehicle (1) on itself about said axis (A), the central chamber (11) of each cylinder (7) not being supplied with fluid in the first configuration such that, in this first configuration, the cylinder (7) of each steering mechanism (6) forms the equivalent of a cylinder with a piston and two rods, the central chamber (11) being in the second configuration, in which it is able to be supplied with fluid, characterized in that the vehicle (1) comprises, to fluidically connect the cylinders (7) of the steering mechanisms (6) to the one or more pressurized-fluid sources (17, 18), a first and a second fluid circuit (15, 16), the first fluid circuit (15) being an active circuit in the first configuration, the second fluid circuit (16) being an active circuit in the second configuration, the second fluid circuit (16) being, for the cylinder (7) of each steering mechanism (6), configured such that, when the central chamber (11) of said cylinder forms an intake chamber, the end chambers (121, 122) of said cylinder form exhaust chambers, and vice versa, this second fluid circuit (16) being equipped with a flow splitter (25) for supplying each end chamber (121, 122) with fluid at the same flow rate.

2. Self-propelled vehicle (1) according to claim 1, characterized in that the flow splitter (25) of the second fluid circuit (16), which is preferably a geared flow splitter (25), is interposed between the pressure source (18) of the second fluid circuit (16) and the end chambers (121, 122) of the cylinders (7).

3. Self-propelled vehicle (1) according to claim 1, characterized in that the second circuit (16) comprises a first circuit portion (161) between the pressurized-fluid source (18) of the second circuit (16) and the central chamber (11) of each cylinder (7) and a second circuit portion (162) extending between the pressurized-fluid source (18) of the second circuit (16) and each end chamber (121, 122) of each cylinder (7), in that the first circuit portion (161) extends from the pressurized-fluid source (18) of the second circuit (16) to a connection node (163) where said first circuit portion (161) is divided into two sections (1611, 1612), one of which connects the connection node (163) to the central chamber (11) of one of the cylinders (7) and the other one of which connects the connection node (163) to the central chamber (11) of the other cylinder (7), and in that the second circuit portion (162) is divided at the flow splitter (25) into four sections (1621, 1622, 1623, 1624) each connecting the flow splitter (25) to an end chamber (121, 122) of a cylinder (7) that is distinct from one section to the next.

4. Self-propelled vehicle (1) according to claim 1, characterized in that the second fluid circuit (16) is equipped with an at least three-position directional control valve (19) interposed between the pressurized-fluid source (18) of the second fluid circuit (16) and the cylinders (7), in that the first position of the directional control valve (19), in which no chamber of the cylinders (7) is supplied by said second fluid circuit (16), corresponds to the selector (13) being positioned in the first configuration, in that the second position of the directional control valve (19), in which the central chamber (11) of each cylinder (7) is a fluid supply chamber and the end chambers (121, 122) are exhaust chambers, corresponds at least to the selector (13) being positioned in the second configuration, and in that the third position of the directional control valve (19), in which the central chamber (11) is an exhaust chamber and the end chambers (121, 122) are fluid supply chambers, corresponds to the selector (13) being moved in order to change from the second to the first configuration.

5. Self-propelled vehicle (1) according to claim 1, characterized in that the first and second fluid circuits (15, 16) each comprise at least one individual circuit portion and one circuit portion (26) shared with the other circuit, in that the or at least one of the portions (26) shared by the first and second circuits (15, 16) is placed between one of the end chambers (121, 122) of a cylinder (7) and a junction node (27) provided with a switching member (28), in that said switching member (28) is mounted movably between a first position, in which the shared portion (26) is in fluidic communication with an individual portion of the first circuit (15), and a second position, in which the shared portion (26) is in fluidic communication with an individual portion of the second circuit (16), and in that the first position of the switching member (28) corresponds to the selector (13) being positioned in the first configuration, and the second position of the switching member (28) corresponds to the selector being positioned in the second configuration.

6. Self-propelled vehicle (1) according to claim 5, characterized in that the vehicle (1) comprises a control unit (292) for the or each switching member (28), said control unit (292) being configured to acquire data regarding the position of the selector (13) and to control the switching members (28) as a function of said data.

7. Self-propelled vehicle according to claim 1, characterized in that the body of each cylinder comprises, to supply the central chamber of said cylinder with fluid, an opening formed in the median zone of said body considered with reference to the two ends of said body.

8. Self-propelled vehicle according to claim 7, characterized in that at least part of the opening formed in the median zone of the body of each cylinder considered with reference to the two ends of said body extends equidistantly from the ends of said body.

9. Self-propelled vehicle according to either of claims 7 and 8, characterized in that, in the first configuration, the pistons of one and the same cylinder move conjointly by simply making bearing contact against one another.

10. Self-propelled vehicle according to claim 1, characterized in that it comprises a first detection device for detecting at least one parameter indicative of the position referred to as straight position of the front wheels and a second detection device for detecting at least one parameter indicative of the position referred to as straight position of the rear wheels, in that the straight position of the front or respectively rear wheels corresponds to a position in which the front or respectively rear wheels are parallel to one another and to the longitudinal axis of the vehicle considered along the front/rear direction of the vehicle, and in that the vehicle comprises a control unit configured to permit the actuation of the selector and allow it to change from the position corresponding to the first configuration to the position corresponding to the second configuration solely in the straight position of the front and rear wheels.
